(19) United States
(12) Patent Application Publication
(10) Pub. No.: US 2025/0043214 A1
(43) Pub. Date: Feb. 6, 2025

(54) CLEANING COMPOSITION, CHEMICAL-MECHANICAL PROCESS, AND CONTINUOUS HYDRODYNAMIC SYSTEM FOR CONTAMINANT CONTROL IN INDUSTRIAL MACHINES

(71) Applicants: RICARDO REIS DE CARVALHO, Valinhos (BR); ANA CAROLINA DA COSTA CARVALHO, Valinhos (BR)

(72) Inventors: RICARDO REIS DE CARVALHO, Valinhos (BR); LUIZ ANTONIO FONSECA DE GODOY JUNIOR, Valinhos (BR); JÉSSICA KUNSMINSKAS DA SILVA, Valinhos (BR); RICARDO DE LIMA BARRETO, Valinhos (BR)

(21) Appl. No.: 18/779,690

(22) Filed: Jul. 22, 2024

(30) Foreign Application Priority Data
Aug. 2, 2023 (BR) 1020230155774

(51) Int. Cl. C11D 3/39; C11D 3/00; C11D 3/12

(52) U.S. Cl. CPC C11D 3/3942; C11D 3/0052; C11D 3/1213; C11D 2111/12; C11D 2111/44

(57) ABSTRACT

Cleaning compositions, chemical-mechanical processes, and a system for treating clothing used in machines of the pulp and paper, textile, tile production, and tanning industries and other industrial processes, without using steam, for the purpose of cleaning off the hydrophobic organic and inorganic contaminants found in the manufacturing processes of the pulp and paper industry, known as pitch, stickies, and others, originating in virgin pulp and scrap paper. The compositions are made up of liquid and gas reagents and involve oxidizing formulations, surfactants, and nanobubbles, employed in a chemical-mechanical process that uses nanobubble production equipment, which, jointly with chemicals, provides deeper, more advanced cleaning, leading to higher energy efficiency and an optimized consumption of chemicals.

### FIELD OF THE INVENTION

This invention covers cleaning compositions, a chemical-mechanical process, and a system for treating clothing used in machines of the pulp and paper, textile, tile production, and tanning industries, without using steam, for the purpose of cleaning off the hydrophobic organic contaminants found in the manufacturing processes of the pulp and paper industry, known as pitch, stickies, and others, originating in virgin pulp and scrap paper, on top of other types of organic as well as inorganic contaminants found in processes of the pulp and paper, textile, tile production, and tanning industry.

Possible compositions come from a combination of oxidizing elements, surfactants, and liquids containing nanobubbles, which are used in various combinations and times when they are inserted in the cleaning process for the clothing, with no need for temperature and pressure changes.

The system found in the state of the art of the pulp and paper industry comprises chemical, mechanical, and/or chemical-mechanical processes that combine thermodynamic equipment like a thermal injection pump or a heat exchanger, which are capable of combining water, steam, and chemicals to produce a solution activated by pressure and temperature with a high cleaning power. However, in this invention, the chemical-mechanical processes do not use either steam or pressure increases, which is replaced by equipment that conducts cavitation, thus producing nanobubbles that, jointly with the chemicals, are capable of performing deeper, more advanced cleaning with a synergistic effect, with no need for high temperatures and pressure, which enables higher energy efficiency by replacing steam, which is increasingly limited for paper manufacturers, while attaining an optimized consumption of chemicals.

### FUNDAMENTALS OF THE INVENTION

The hydrophobic organic contaminants found in the manufacturing processes of the pulp and paper industry, known as pitch, stickies, and others, originate respectively in virgin pulp and scrap paper and are the primary causes of the problems found in final paper production, such as sheet breaks, paper holes, production losses from manufacturing and conversion, use of solvents, and operational rework.

Treating the clothing of pulp and paper machines is a reality today and vitally important to keep the high productivity levels, production cost, and quality of produced paper, in particular in the face of the currently high levels of closed water loops, in which the contents of organic and inorganic contaminants are rising, leading to a higher number of buildups that compromise water drainability and, as a consequence, the service life of felts and screens.

The approaches to cleaning and conditioning the clothing entail chemical, mechanical, and chemical-mechanical methods, although a trend has been noticed toward mechanical and or chemical-mechanical approaches with a focus on optimizing the consumption of chemicals and higher energy efficiency; specifically, a reduction in steam consumption is sought, as generation costs are on the rise.

An actual reduction in steam consumption at pulp and paper mills does not involve economic gains only, but in particular environmental addition to reducing the demand for fossil fuels, when considering the burning of black liquor in the recovery boiler, one can understand the potential additional benefit of reducing the emission of sulfur-derived substances present in the kraft pulping process and that give an unpleasant odor to gas emissions affecting the surroundings of these mills, which is worse when such mills are near urban areas.

Nonetheless, the most widely known techniques are the mechanical approaches, such as the one in patent WO2013/154802 (priority U.S. 61/622,622), which applies steam to heat and soften the contaminants in clothing, as well as the chemical-mechanical approach in PI0503029-3 (partially authored by this group of inventors), internationally extended in WO2008/012597, which combines water, steam, and chemicals to produce a cleaning solution with a high detergency power.

More specifically addressing WO2013/154802, this one indicates that the high levels of pressure (between 20 and 55 bar) and temperature (between 10° and 135° C.) do not cause or speed up the wearing of clothing (felts and screens), but doubt remains as to the actual effectiveness of mechanical cleaning using steam and overheated water only, since they suggest that a cleaning solution should be occasionally applied at the same time, which even conflicts with other patents preceding this techniques that involve applying chemicals under high pressure and temperature.

As to the chemical-mechanical approach in patent PI0503029-3, internationally extended in WO2008/012597, in spite of the high cleaning efficiency achieved by the heated and pressurized chemical solution, it has been from time to time suffering from a restriction or even, in some cases, unavailability of steam at pulp and paper mills, taking into account that this resources is crucial to the operation of the thermodynamic equipment that comprises a thermal injection pump. In addition, even using biodegradable chemicals, which are much less aggressive than washing soda and concentrated acids, or pure solvents of higher toxicity (e.g. Xylene), there are still opportunities for dosage improvements by optimizing the consumption of chemicals.

The application of enzymatic products is also worth mentioned, which was pioneered in U.S. 60/395,528 and globally extended in WO 2004/007839 and began to consider the degradation mechanisms of the main substances that comprise these buildups, as well as the use of oxidizing cleaners in CN108822991 with aims to increase the removal of more resistant organic contaminants, such as buildups of water-resistant resins and fines that are typical of tissue paper factories.

With regard to the enzymatic technology proposed in WO 2004/007839, in spite of the correct conception in terms of chemical functionality based on the selective degradation of the contaminants present in the buildups, in practice, it can be observed that the activity of enzymes is far from meeting the dynamic imposed by the very short residence time on felts and screens for an effective treatment. Moreover, there is always a concern about potentially degrading other substances that are useful to the paper, as well as limiting a hot application or an application at pH ranges outside the neutral condition, which completely or partially inactivates a large number of enzymes, thus preventing an extensive advance of their application in this segment.

Finally, with regard to clothing cleaning methods that are purely chemical, although Chinese patent CN108822991 attacks hard-to-degrade contaminants such as water-resistant resins, a continuous use of oxidizing formulations at a high concentration can be detrimental to the service life of the clothing and parts of the machine, not to mention the limited application of alkaline formulations jointly with peroxide and/or persalt solutions, since alkalinity speeds up their degradation, requiring an use of neutral and/or acidic cleaners that are often not the most effective ones in removing certain contaminants that comprise the buildups of pitch, stickies, and similar ones commonly found at pulp and paper mills.

Based problems explained here, none of the chemical, chemical-mechanical, and mechanical methods existing in the state of the art for treating clothing of pulp and paper machines is able to solve the above problems, not to mention their energy expenditure and environmental pollution. This has encouraged many attempts to develop other forms of treating the clothing of pulp and paper machines, preferably ones that achieve solutions with a reduced consumption of chemicals and not requiring an increased pressure, temperature, and steam production.

In this regard, particular attention is drawn to the tensioactive properties of nanobubbles, the cleaning application of which has widely spread into countless fields, from detergent-free washing machines (JP 2009172060) to even the graphic industry where print rolls are kept clean by removing the impregnated paint through an automated application of a cleaning solution in the form of a spray rich in compressed-air nanobubbles, with no need for solvents (JP2009214363).

Nanobubbles are bubbles with a nanometric diameter (<1 μm) with peculiar characteristics, such as increased surface area, electrostatic c polarization, surfactant and sterilizing activity, localized high-pressure instantaneous generation, and reduced buoyant force. Such properties, as well as the very existence of nanobubbles, were confirmed by Japanese inventor Akira Yabe and his collaborators, with the first nanobubble generator and pioneering applications protected in JP2002-288963 and US2006/0054205.

The cleaning mechanism of nanobubbles is due to two supplementary effects: first, due to the high surfactant activity, the particles are adsorbed on their interface by chemical affinity and any dirt is removed. It is worth highlighting that 100-nm nanobubbles exhibit a surface area that is s a dozen thousand times as large as conventional bubbles.

In addition, nanobubbles measuring 50 to 100 nm exhibit an internal pressure of a few dozen atmospheres (atms) due to their surface tension with water, so they release a large quantity of kinetic energy upon breaking through a blast of air. This is the energy that helps boost the cleaning of the substrate surface impregnated with dirt, though there have been no reports that it was tested with clothing (felts and screens) of pulp and paper machines.

Moreover, more recently, inventors from the University of California, in US20190118142, reported their discovery that nanobubbles are excellent for removing calcium carbonate (CaCO3) buildups, which account for a classic problem when treating aqueous systems with high hardness. More specifically, they found a high concentration of hydroxyl anions (OH⁻) built up on the spherical surface of nanobubbles, which begin to repel each other and become highly reactive species with CaCO3. The primary application developed in this specific case was as an antiscalant for the maintenance of membranes in reverse-osmosis filters, increasing by as many as ten times the downtimes for cleaning.

We could list countless industrial applications of nanobubbles, but we have chosen to highlight three works specifically relating to contaminant control: the first one from Japanese company Sharp (US20070284316), which pioneered the use of ozone nanobubbles to treat industrial waters in cooling towers, the second one in floating cells to increase solid-gas interaction (US20170043356), and the third one in soil remediation systems to remove recalcitrant organic pollutants like Benzene, Toluene, Ethylbenzene, Xyleno (BTEX) and heavy metals (KR1017680060000).

It is finally worth highlighting that, currently, conventional methods to generate nanobubbles are mastered by a person skilled in the art, who can count on commercially available models that are based on cavitation phenomena such as the device called CAVITRON from U.S. company ARDE Barinco or those using Venturi tubes or turbo mixers such as the one manufactured by Japanese company Nikuni.

We should stress the many patent applications that are clarifying in terms of proving important practical aspects in industrial cleaning, from which we have chosen the use of nanobubbles in washing machines (JP2009172060), the application in the graphic industry for roll cleaning (JP2009214363), maintenance of membranes of reverse-osmosis filters (US20190118142), treatment of industrial waters from cooling towers (US20070284316), application in floating cells (US20170043356), and soil remediation (KR1017680060000).

The technical limitations of the works that have supported the state of the art in regards to the properties and mechanisms of action of nanobubbles did not address cleaning systems specifically focused on treating the clothing (felts and screens) of pulp and paper machines. This makes it interesting to explore the cleaning effect of nanobubbles in clothing for pulp and paper machines, in order to investigate how they could contribute in this context.

### BRIEF DESCRIPTION OF THE INVENTION

This invention therefore covers cleaning compositions, a chemical-mechanical process, and a system for treating clothing used in machines of the pulp and paper and related industries, developed from studies comparing various combinations of oxidizing agents, surfactants, and nanobubbles, inserted jointly or separately at different steps of the cleaning process for hydrophobic organic contaminants found in the manufacturing processes of the pulp and paper industry, known as pitch, stickies, and others, in order to obtain the best system for treating the clothing.

The group of inventors noticed that the nanobubbles by themselves had a limited cleaning effect. That is, it was reduced when compared to the traditional methods present in the state of the art. On the other hand, when the nanobubbles were combined with certain products used in traditional methods, there was an unexpected effect, which was synergistic in some combinations and at specific times of the process, which constitutes the core of this invention.

Thus, this invention has as its starting point a chemical-mechanical system already known in the state of the art, as described in patent PI0503029-3 (WO2008/012597), which comprises thermodynamic equipment like a thermal injection pump or a heat exchanger that combines water, steam, and chemicals to produce a solution activated by pressure and temperature with a high cleaning power. However, this clothing treatment system uses hydrodynamic equipment that is comprised of a fluid mixing chamber that is capable of boosting the contact between the liquid and gas phases, thus promoting some homogenization between previously generated nanobubbles, combined with oxidizing formulations and surfactant formulations (alkaline, neutral, and/or acidic) that are applied to felts and screens with no need for steam through an application using showers with spraying nozzles.

In this regard, when associating nanobubbles, which are relatively stable e in a solution and exhibit surfactant activity, with conventional oxidizing formulations and surfactant formulations, which capable of detaching, dispersing, and degrading contaminants, we can finally achieve a cleaning system of similar or superior efficiency when compared to the current hot cleaning technologies using steam. This optimizes the consumption of chemicals with positive impacts from an energetic and environmental standpoint.

More specifically, a chemical-mechanical approach to this invention has high-value advantages for the pulp and paper industry, especially when compared to an application of chemicals at high temperatures and pressure as found in the state of the art, enabling a complete elimination of machine downtimes, reduction in sheet breaks (<8%) with expressive productivity gains (>3%), increased service life of clothing (>20%), a reduction in the specific consumption of steam (<3%), and a better transverse profile for the sheet.

As a consequence, the first mode of this invention refers to cleaning compositions that may contain combinations of 0 to 20% oxidizing formulations, 0 to 20% surfactant formulations, and 60 to 99% of a solution with nanobubbles, either previously mixed or inserted at different times of the process, which will jointly act to clean felts and screens of the clothing used in the pulp and paper industry.

The compounds that can be mixed to form the active part of the cleaning composition under this invention will be called liquid reagents (LR) and gas reagents (GR), with the following abbreviations (acronyms):

TABLE 1
Acronyms for the liquid reagents (LR)
and gas reagents (GR) of this invention

| ACRONYM | COMPONENTS |
|---|---|
| LR1 | Neutral or acidic formulation |
| | Neutral or acidic surfactant formulation |
| LR2 | Oxidizing formulation |
| | hydrogen peroxide |
| | zinc peroxide |
| | Persalts |
| | ammonium persulfate |
| | potassium persulfate |
| | sodium persulfate |
| LR3 | Alkaline formulation |
| | Alkaline Surfactant Formulation |
| GR1 | Oxidizing species |
| | Ozone |
| | chlorine dioxide |
| GR2 | Solution with nanobubbles |

In addition, the above chemicals may be joined with other elements not directly active in the cleaning, which are or can be used in the pulp and paper industry and other related segments (tanning, textile, and tile production), such as pH controllers, inactive ingredients, vehicles, antifoaming agents, stabilizers, conservatives, etc.

A second modality of this invention refers to a clothing cleaning process that includes a first step in a hydrodynamic chamber that performs the mixing of liquid and gas reagents (LR and GR) in a mixer (101). A second step is included for spraying (103) by injection nozzles (103A) of one of the chosen compositions onto the felt or screen, preferably in the direction of the roll. In a preferred mode of the process, the mixing performed in the mixer (101) will contain LR1, LR2, GR1, and GR2, with LR3 injected separately (102) by injection nozzles (102A) that are independent from the injection nozzles of the mixer (103A), as described in FIG. 1.

Finally, the third and last mode of this invention refers to the Continuous hydrodynamic cleaning system (100) containing equipment such as sprayers, a fluid mixing chamber (101), injection nozzles, clothing rolls, which are typical of the pulp and paper industry, associated in this invention with nanobubble-generating equipment and chemicals as described in Table 1. The choice of the best oxidizing formulation and the exact final composition will depend the specific contaminants present in the clothing used in each segment.

### BRIEF DESCRIPTION OF THE FIGURES

The figures mentioned below represent a particular embodiment of the invention, though their mention does not impose any limitation beyond those shown in the claims.

FIG. 1—illustrates a schematic view of the system (100) for treating clothing of machines of the pulp and paper and related industries without using steam, where: i—direction of the clothing (felt/screen)—roll side; 101—fluid mixing chamber; 102—shower; 102A—injection nozzles; 103—shower; 103A—injection nozzles; LR1—neutral or acidic formulation; LR2—oxidizing formulation; LR3—alkaline formulation; GR1—oxidizing species; and GR2—Solution with nanobubbles.

FIG. 2—details the schematic view of the outer part of the fluid mixing chamber (101), where: 101A—outer body of the mixing chamber; 101B—inlet of fluid GR2; 101C—inlet of fluids LR1 and LR2; 101D—inlet of fluid GR1; 101E—outlet of the fluid mix from the mixing chamber.

FIG. 3—represents a schematic view of the equipment used in the procedure of laboratory analysis of the clothing (felts and screens), where: i—support for 8 felt coupons; ii—3 L mugs; iii—2 L of the immersion solution; iv—area where the coupons are placed; v—the inner surface is hollow (grate) and the outer one is not hollow to submerge the coupons; vi—8×8-cm coupon—Alkaline/acidic extraction; vii—1×8-cm coupon—Solvent extraction.

FIG. 4—represents a graphic with the results of the validation testing of the specific components to be incorporate into the treatment system (100), with axis y showing the cleaning efficiency percentage and axis x the different treatment processes

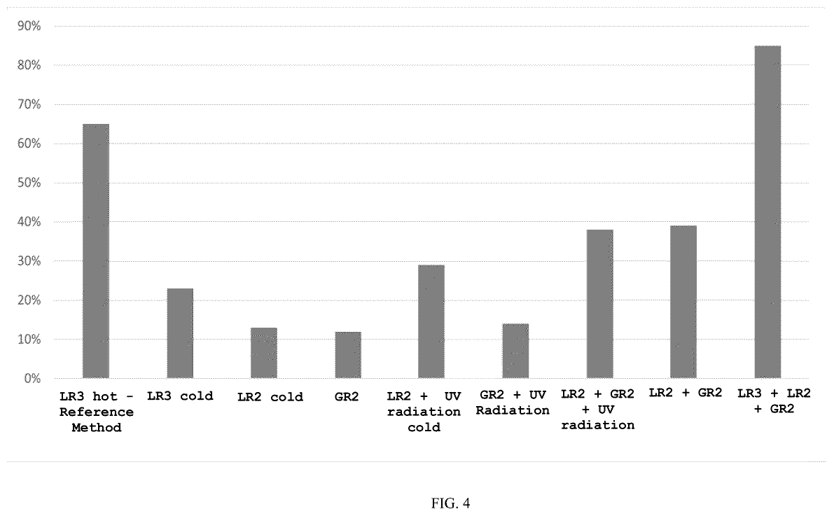

### DETAILED DESCRIPTION OF THE INVENTION

Below is a description of the invention for the purpose of making it easier to understand it, though such description does not impose any limitation other than those shown in the attached claims.

This invention refers, therefore, to different cleaning compositions, chemical-mechanical processes, and a system capable of treating clothing used in machines of the pulp and paper industry a through combined use of nanobubbles, oxidizing formulations, and surfactant formulations, as evidenced from the benefits listed as follows:
A system for cleaning and conditioning clothing is enabled with similar or superior efficiency when compared to the current hot cleaning technologies;
The use of steam as a source of energy is eliminated, taking into account that its costs are on the rise in the paper industry, which can even make its application impossible in some cases;
New hydrodynamic equipment is created that comprises a fluid chamber capable of replacing the current thermodynamic equipment, such as a thermal injection pump or a heat exchanger;
The contact between liquid and gas phases is boosted, thus promoting better homogenization between nanobubbles and the oxidizing formulations and surfactant formulations;
On top of allowing softer oxidizing formulations to be used, such as the hydrogen peroxide, which are harmless to the materials making up the clothing and machine parts at their applied concentrations, this treatment system provides an optimized consumption of chemicals and thus constitutes an environmentally friendly solution.

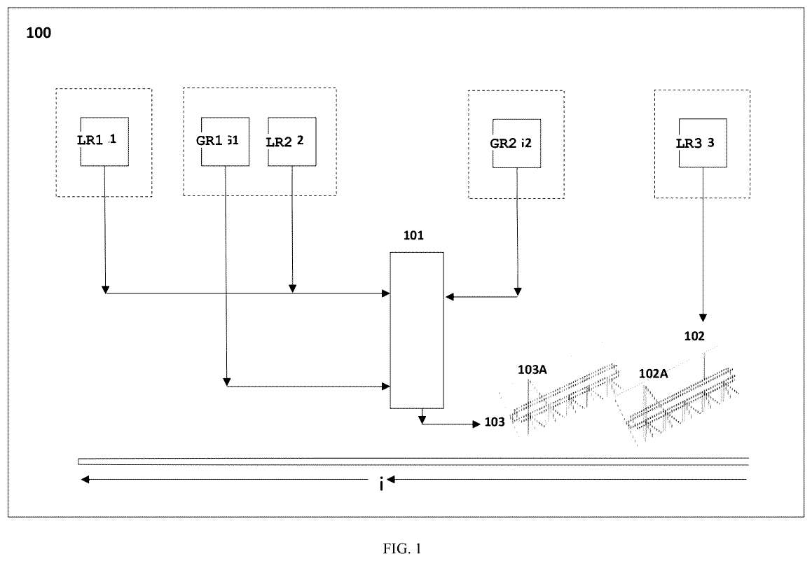

Considering that the core of the invention is the system (100) capable of treating clothing used in machines of the pulp and paper industry through a combined use of nanobubbles, oxidizing formulations, and surfactant formulations, the equipment and chemicals comprising it are described below according to the schematic view illustrated in FIG. 1.

Generally speaking, preferred chemicals of the system (100) with surfactant activity may comprise two Liquid Reagents (LR) and one Gas Reagent (GR), with (LR1) being a neutral or acidic formulation and (LR3) necessarily an alkaline formulation, as well as (GR2), which comprises a solution of nanobubbles. In their turn, the oxidizing species in (GR1) can be ozone or another oxidizing gas such as chlorine dioxide (ClO₂), whereas (LR2) covers formulations of hydrogen peroxide or persalts, such as ammonium persulfate (see Table 1).

The pieces of equipment of the system (100) are comprised of two parts, the first one intended for preparation of the chemicals (liquid and gas reagents), made up of tanks of an appropriate material resistant to a chemical attack, dosing pumps, and level and pressure control instruments for all relevant concentration adjustments during dosing. The second part deals with two parallel routes that allow for a contact between the liquid and gas reagents in the hydrodynamic equipment herein called fluid mixing chamber (101), as well as an individualized, preferred route for prior application of the alkaline surfactant formulation (LR3) to the substrates to be cleaned (felts and screens) through the shower (102) equipped with injector nozzles (102A).

In addition, in a preferred modality of the cleaning process, it is important that the application of the alkaline surfactant formulation (LR3) is the first one to come in contact with the clothing (watch the rotation direction of the felt/screen on the machine) to avoid a degradation of the oxidizing species before they perform their cleaning role. In this case, LR3 would not be part of the cleaning composition, but rather applied separately from the other reagents described in Table 1.

The apparatus herein proposed, more specifically the fluid mixing chamber (101), allows for an injection of multiple liquid and gas reagents and exhibits a unique constructive characteristic that, when speed variations of the flows are sequentially done, causes turbulence between the fluids, thus increasing interactions between reagents in the medium and promotes better homogenization of the fluid mix that is directed at the outlet of the hydrodynamic equipment to the shower (103) equipped with injection nozzles (103A).

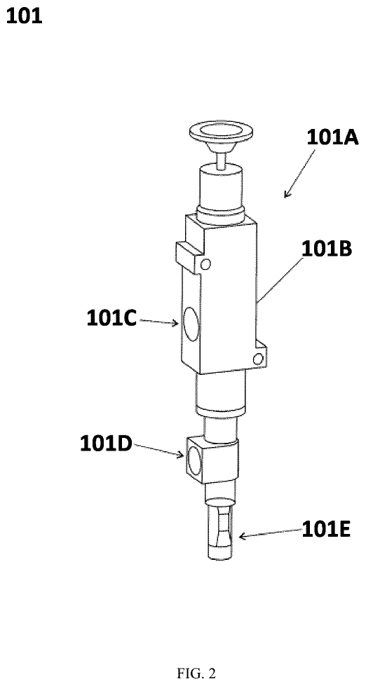

As illustrated in FIG. 2, the fluid mixing chamber (101) is characterized in that it has a set of devices with defined functions to promote a gas/liquid mixture between the nanobubbles present in (GR2), the oxidizing gas (GR1), and the surfactant (LR1) and oxidizing solutions (LR2). The outer body (101A) has a side opening (101B) that allows for the entry of (GR2), which consists of a solution of nanobubbles generated by commercially available equipment such as Cavitron from U.S. company ARDE Barinco or turbomixer from Japanese company Nikuni. On the other side, the opening (101C) allows for the entry of the neutral or acidic surfactant formulation (LR1) and the oxidizing formulation of hydrogen peroxide or persalts (LR2). In its turn, the opening (101D) allows the oxidizing gas (GR1) to enter, which can be ozone or alternatively chlorine dioxide (ClO₂), whereas positioned at the base is the outlet opening (101E) for the final fluid mixture.

Due to the use characteristics, the outer body (101A) can be built with different materials and thicknesses. For pressures up to 15 bar, a synthetic material resistant to chemical attacks can be used, such as PVC. For pressures above 15 bar, however, stainless steel would be advisable. This also applies to the inner components of the device.

The unique antiscalant and surfactant properties of the nanobubbles, associated with the e oxidizing species and surfactant solutions, can not only provide a cleaning power to hydrodynamic systems at the process temperature and under pressure that is as efficient as the thermodynamic system that uses pressure and temperature (above 70° C.) mentioned in the state of the art, patent PI0503029-3 (WO2008/012597). It can also, on top of eliminating steam and reducing the need for chemicals, thus avoiding in increase of the organic load sent to the Wastewater Treatment Plant (WWTP), which constitutes an environmentally friendly technology solution for the paper industry, this invention can use a smaller pressure range than the one used in the state of the art. That being so, the process of this invention works in any pressure ranges, such as 1 to 30 bar, however it already shows efficiency in ranges such as 1 to 4 bar. The preferred ranges depend on the type of operation and must be regulated as per the needs of the industrial process. In the case of pulp and paper, for example, it would be in the range of 1 to 3 bar.

To prove such possibility, a study was conducted with different formulations of chemicals (liquid and/or gas reagents) applied either separately or jointly, using a dedicated gravimetric methodology to analyze the contamination profile of the clothing (actual samples of felts removed from pulp and paper machines), which is based on selective solubilization of the main contaminants found in pulp and paper mills (e.g. pitch, stickies, starch, carbonates, talc, glues, resins, and others). First, solvent, alkali, and acidic extracts are obtained, as well as the ashes at the end of the extractions, allowing the contribution of each class of contaminants to the total solids to be calculated. Later, the samples of contaminated substrate (coupons) are assessed against chemicals (liquid or gas reagents) to determine the cleaning efficiency, which is expressed as percentage (%) from the weight loss under two conditions:
a) Continuous test: more diluted product (e.g. 2%) and longer immersion (120 min);
b) Shock test: more concentrated product (e.g. 5%) and shorter immersion (30 min).

In addition, there are laboratory methods to quantify the contaminants in the cellulose pulp, that is, in previous steps of the production process, which can boost the preparation of the most adequate solution to remove these contaminants from felts and screens. These methods include flow described in the cytometry, as Japanese patent JP2015519483. In this method, the pulp samples are collected and treated with a fluorescent dye that is able to be absorbed by these hydrophobic species and undergo a laser beam to perform the quantification. This monitoring of dirt levels in previous stages of the process allows you to bring forward any necessary adjustments to solution and/or species combinations of the cleaning system, establishing a more appropriate program for conditioning the clothing.

### EXAMPLES

The examples that follow, described with the aid of the attached figures, are provided only as examples of particular embodiments of the invention and are not intended to impose restrictions on it other than those shown in the attached claims. Production experiments have been performed for the components of the composition, with field application and efficacy testing.

### Example 1—Alkaline Extracts

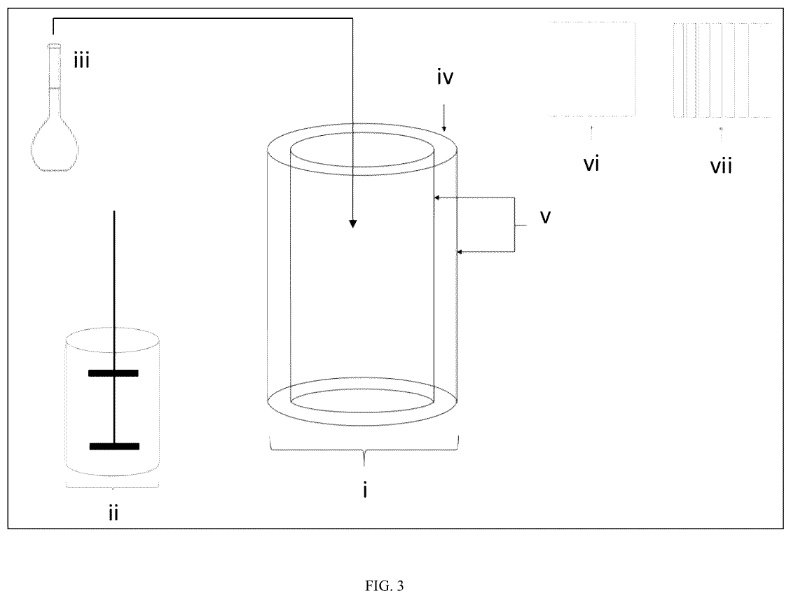

According to the procedure illustrated in FIG. 3, for the case of determination of alkaline extracts, cut the felt in a coupon format to the approximate measures of 64 cm² (8 cm×8 cm, FIG. 3 vi). Whenever possible, cut the coupons across the same line, respecting the direction of the pulp and paper machine. Avoid areas where there might have been a buildup of dirt on the felt surface during machine removal. If necessary, brush the surface of the felt using a rigid brush. Mind the possibility that felt strands may be detaching on the sides of the coupons. Use scissors to remove these strands. Take the coupons (vi or vii) into the hothouse previously heated to 105° C. (+5° C.) for 2 hours. Following that time, transfer them into a desiccator, keeping them there for at least 1 hour. Weigh the coupons on an analytical scale, marking them as M2 (for alkaline extraction) and record the coupon weights in grams (g). In a 3.0 L stainless steel mug, prepare 2.0 L of an aqueous solution at 20% of NaOH 50%. Store the grate inside the mug, turn the heating plate on, wait until the system reaches the temperature of 82° C. (+/−3° C.). Gently place the coupons inside the grate (FIG. 3 iv), leaving them completely immersed in the solution (FIG. 3 iii), lower the mechanical agitator, and start shaking it vigorously. Control the heating system to a temperature of 82° C. (+/−3° C.) for 120 minutes. After that time, turn off the heating system and the agitation, remove the coupons from the mug, and rinse them in running water, warm, if possible, until the absence of alkalinity in the medium is evidenced. This can be done by measuring the pH of the solution after rinsing. Once again, take the 1^{st} coupon into the hothouse (the one with M2 weight), previously heated to 105° C. (+/−5° C.) for 2 hours. Following that time, transfer it into a desiccator, keeping it there for at least 1 hour. Weigh one of the coupons on an analytical scale. Finally, taking into account that M4 is the weight (g) of the clean coupon, the alkaline extracts are calculated (%) using the formula below:

$$Alkaline extracts = weight loss in an alkaline medium = ( \frac{{M}_{2} - {M}_{4}}{{M}_{2}} ) \times 100$$

Where:
M₂=weight of the dry coupon, in grams, before extraction.
M₄=weight of the dry coupon, in grams, after alkaline extraction.

### Example 2—Solvent and Acidic Extracts

For the solvent and acidic extracts, as well as to assess the cleaning efficiency of the cleaning chemicals, whether liquid or gas reagents, variations of the above-mentioned procedure are used, only changing the immersion solution (iii) as well as a few other operational details and mathematical calculations that will be omitted here, as they are not within the scope of this invention.

### Example 3—Validation Testing of the Different Compositions

Initially, a cold assessment (room temperature) and a hot assessment (82° C.) were performed with no chemicals. Then, the efficiency of the separate chemicals was compared, with and without nanobubbles present. Also, the effect of the ultraviolet radiation (UV) during the treatment was assessed. The continuous application condition (A) was used for all testing with different chemicals and their combinations. In all tests, the LR3 concentration was 2% and LR2 was at 1%. The coupons were chosen from paper machines from different segments such as pulp, packaging paper, tissue, and printing/writing, for which the contamination profile of the extracts is significantly different. In addition, felt from a tile production machine was also assessed. A saturated solution of nanobubbles was generated, and the commercial equipment used in this process was a Holly Nano Bubble Generator (HLYZ-01 model). The validation tests of the specific components of the new technology developed were ran on coupons from a fluted paper machine and the results are shown in Table 2.

TABLE 2
Assessment of Components of the Technology - Conditioning
of Felt from a Fluted Paper Machine

| | | Cleaning |
|---|---|---|
| Test | Components | Efficiency (%) |
| 1 | LR3 (alkaline form.) | 65 |
| | hot (82° C.) - reference | |
| 2 | LR3 (alkaline form.) cold (r.t.) | 23 |
| 3 | LR2 (oxidizing form.) cold (r.t.) | 13 |
| 4 | GR2 (nanobubbles) | 12 |
| 5 | LR2 cold (r.t.) + UV Radiation | 29 |
| 6 | GR2 + UV Radiation | 14 |
| 7 | LR2 + GR2 | 39 |
| 8 | LR2 + GR2 + UV Radiation | 38 |
| 9 | LR3 + LR2 + GR2 | 85 |

The cleaning efficiencies of the coupons undergoing separate and combined treatments were assessed. The testing procedure is identical to the one described in Examples 1 or 2, and the hot LR3 alkaline formulation (82° C.) was used as reference (Test 1), which accounts for a 65% efficiency in cleaning. Test 2 refers to the cold LR3 alkaline treatment (room temperature—r.t.), and we can observe an efficiency drop relatively to the hot treatment (from 65 to 23%). Tests 3 and 4 respectively use the oxidizing formulation LR2 (solution at 50% hydrogen peroxide or persalt) and the solution of nanobubbles GR2, leading to similar results in cleaning (13% and 12%, respectively). Test 5 refers to the incorporation of UV radiation into the treatment with the oxidizing formulation LR2, which leads to an increase from 13 to 29% cleaning efficiency. Test 6, on the other hand, incorporates UV radiation into the treatment with nanobubbles GR2, demonstrating that there is no considerable gain in cleaning (from 12 to 14% efficiency). Tests 7 and 8 aim to assess the effect of UV radiation on the combination between the oxidizing formulation LR2 and nanobubbles GR2. By combining only the oxidizing formulation LR2 and nanobubbles GR2 (Test 7), the cleaning efficiency is 39%. But by combining all three components (Test 8), we obtain 38% efficiency, which demonstrates that UV radiation becomes crucial in the combined treatment. Finally, Test 9 shows the effect of the cold combination of the surfactant formulation LR3, oxidizing formulation LR2, and nanobubbles GR2, leading to 85% efficiency, which accounts for a significantly increase by 20% efficiency when compared to the reference hot treatment (Test 1).

### Example 4—Validation Testing in Various Segments

Then, an assessment was performed as to the effect of a combination of the different components incorporated into the system proposed in this technology—LR1, GR1, LR2, GR2, and LR3—on the cleaning efficiency for coupons from various segments, by comparing the cleaning activity of the reference method (LR3 2% hot) to this system employing a LR2 concentration at 1% and different oxidizing formulations.

The tests were run according to the procedure described in Examples 1 or 2, and the main results of the study have been recorded in the table below:

TABLE 3
Efficiency of Felt Conditioning for various segments

| | | Cleaning |
|---|---|---|
| Components | Segment | Efficiency (%) |
| LR3 (Alkaline Surfactant | Packaging | 65 |
| Formulation) at 82° C. | | |
| LR3 + LR2 (hydrogen | Packaging | 85 |
| peroxide) + GR2 | | |
| LR3 + LR2 (ammonium | Packaging | 88 |
| persulfate) + GR2 | | |
| LR3 (Alkaline Surfactant | Printing and | 47 |
| Formulation) at 82° C. | writing | |
| LR3 + LR2 (potassium | Printing and | 58 |
| persulfate) + GR2 | writing | |
| LR3 (Alkaline Surfactant | Pulp | 51 |
| Formulation) at 82° C. | | |
| LR3 + LR2 (hydrogen | Pulp | 65 |
| peroxide) + GR2 | | |
| LR3 + LR2 (ammonium | Pulp | 91 |
| persulfate) + GR2 | | |
| LR3 (Alkaline Surfactant | Tissue | 44 |
| Formulation) at 82° C. | | |
| LR3 + LR2 (ammonium | Tissue | 43 |
| persulfate) + GR2 | | |
| LR3 (Alkaline Surfactant | Tiles | 6 |
| Formulation) at 82° C. | | |
| LR3 + LR2 (ammonium | Tiles | 18 |
| persulfate) + GR2 | | |

The results achieved indicated that the choice of the best oxidizing formulation will depend on the specific contaminants present in the clothing of each segment and corroborate the proposal of a clothing cleaning system that exhibits similar or even higher efficiency than the conventional hot system.

Finally, depending on the countless possibilities provided for the system herein proposed, changes can be expected as to the combinations of chemical formulations, equipment, different sequences, combination with other equipment or chemicals, order, process and application conditions, and any parts of the system can be removed or recombined without denaturing the core innovation, which consists of a treatment at process temperature of clothing used in pulp and paper machines, as well as in similar or related industries.

Thus, in spite of the particular embodiments herein detailed, this Invention Patent application must not be deemed to be limited to such descriptions. It must also be clarified to the experts of the many fields involved that any modifications, whether or not apparent, can be incorporate as an integral part of this document and yet remain in accordance with the scope of the claims that follow.

It is known that a technician skilled in the art, based on the information and examples shown in this document, can make particular embodiments of this invention not expressly described here, but that perform equal or similar functions, to achieve results of the same nature. Such equivalent embodiments are covered by the attached claims.

1. A cleaning composition for clothing used in industrial machines, wherein the cleaning composition is applied during the process of cleaning felts and screens of the clothing and covers a combination of Liquid Reagents (LR) and Gas Reagents (GR), covering a quantity of 0 to 20% oxidizing formulations, 0 to 20% surfactant formulations, and 60 to 99% of a solution of nanobubbles, previously mixed or inserted at different times of the process, which will jointly act to clean off pitch, stickies, starch, carbonates, talc, glues, resins, and other organic and inorganic compounds originating in virgin pulp, scrap paper, and residual chemicals employed in the process, which are stuck during the production process on paper machines in different segments such as pulp, packaging paper, tissue, and printing/writing, for which the contamination profile of the extracts is significantly different, as well as in applications in other industries such as tanning, textile, and tile production.

2. The cleaning composition according to claim 1, wherein the preferred composition can be chosen from a combination of:
a) a quantity of 0 to 20% liquid reagent chosen from: LR1—neutral or acidic formulation, preferably a neutral or acidic surfactant formulation; LR2—oxidizing formulation, chosen from: hydrogen peroxide, zinc peroxide, and/or persalts, such as ammonium, potassium, and/or sodium persulfate;
b) a quantity of 0 to 20% of LR3—alkaline formulation, preferably an alkaline surfactant formulation; and
c) a quantity of 60 to 99% of the gas reagent, which can be chosen from GR1—gas with oxidizing species, such as ozone or another oxidizing gas, like chlorine dioxide (ClO2); and/or GR2—a solution containing nanobubbles.

3. The cleaning composition according to claim 1, wherein the preferred compositions will always have a quantity of GR2 and that the other reagents (LR or GR) of the composition may vary according to the type of segment, such as: pulp, packaging paper, tissue, tanning, textile, and tile production, because they exhibit contamination profiles that are significantly different.

4. The cleaning composition according to claim 1, wherein the preferred composition is made up of the reagents LR1, GR1, LR2, and GR2, which may be mixed in the fluid mixing chamber, and LR3, which can be applied separately to the clothing, avoiding reactions inside the mixer.

5. The cleaning composition according to claim 1, wherein the compositions can optionally be supplemented by pH controllers, inactive ingredients, vehicles, antifoaming agents, stabilizers, conservatives, and other elements not directly active in the cleaning, which are or can be used in the pulp and paper, tanning, textile, and tile production industries.

6. A cleaning process for clothing used in industrial machines, wherein the cleaning process uses the cleaning composition according to claim 1, but with a possibility that oxidizing elements, surfactants, and nanobubbles may be inserted at the same time or at different times of the industrial cleaning process on machines in different segments such as pulp and paper, packaging paper, tissue, and printing/writing, as well as in similar and related industries such as tanning, textile, and tile production, on top of including the following stages:
a) obtaining and preparing the reagents;
b) mixing the reagents (LR and GR) in a hydrodynamic chamber;
c) boosting the contact between liquid and gas phases, thus promoting better homogenization between nanobubbles and the oxidizing species and surfactant solutions;
d) spraying the separate products or the compositions through injection nozzles onto the felt or screen, preferably in the roll direction, with pressure possibly varying from 1 to 30 bar, depending on the type of industrial operation and process.

7. The cleaning process according to claim 6, wherein the mixture performed in the mixer contains LR1, LR2, GR1, and GR2, with LR3 injected separately by injection nozzles that are independent from the injection nozzles of the mixer, both under a preferred pressure of 1 to 4 bar, in the case of pulp and paper, preferably between 1 and 3 bar.

8. A continuous hydrodynamic system for cleaning of clothing used in industrial machines, wherein the continuous hydrodynamic system is used for cleaning felts and screens of the clothing of the industrial cleaning process of machines in the pulp and paper, packaging paper, tissue, tanning, textile, tile production, and similar and related industries, covering:
a) the cleaning composition according to claim;
b) a cleaning process for clothing used in industrial machines;
c) equipment capable of producing formulations containing nanobubbles;
d) hydrodynamic equipment capable of replacing the current thermodynamic equipment, such as a thermal injection pump or a heat exchanger;
c) fluid mixing chamber capable of boosting the contact between the liquid and gas phases, thus promoting some homogenization between previously generated nanobubbles (GR2), combined with the reagents LR1, LR2, LR3, and/or GR1; and
f) showers with spraying nozzles capable of spraying the reagents onto the roll of the clothing at pressures from 1 to 30 bar depending on the type of industrial operation and process,
wherein the cleaning process uses the cleaning composition, but with a possibility that oxidizing elements, surfactants, and nanobubbles may be inserted at the same time or at different times of the industrial cleaning process on machines in different segments such as pulp and paper, packaging paper, tissue, and printing/writing, as well as in similar and related industries such as tanning, textile, and tile production, on top of including the following stages:
obtaining and preparing the reagents;
mixing the reagents (LR and GR) in a hydrodynamic chamber;
boosting the contact between liquid and gas phases, thus promoting better homogenization between nanobubbles and the oxidizing species and surfactant solutions;
spraying the separate products or the compositions through injection nozzles onto the felt or screen, preferably in the roll direction, with pressure possibly varying from 1 to 30 bar, depending on the type of industrial operation and process.

9. The continuous hydrodynamic system according to claim 8, wherein the fluid mixing chamber has an outer body with a side opening that allows for (GR2) to enter; on the other side, the opening allows for the entry of the LR1 and LR2; an opening allows the oxidizing gas (GR1) to enter, whereas positioned at the base is the outlet opening for the final fluid mixture, which can be made of different materials and thicknesses according to the function, use, and pressure amount, which preferably varies from 1 to 4 bar and in the pulp and paper industry is preferably between 1 and 3 bar.
